(19) United States
(12) Patent Application Publication
(10) Pub. No.: US 2003/0108087 A1
(43) Pub. Date: Jun. 12, 2003

(54) Method and base station for providing transmit diversity

(76) Inventors: Itzhak Shperling, Bnei-Brak (IL); Noam Amram, Holon (IL); Reuven Meidan, Ramat Hasharon (IL); Sergey Bondarenko, Ramat Gan (IL); Shlomo Barash, Holon (IL)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/011,026

(22) Filed: Dec. 6, 2001

(51) Int. Cl. H04K 1/00

(52) U.S. Cl. 375/146

(57) ABSTRACT

In accordance with the preferred embodiments of the present invention, a method (400) and a base station (140) for providing a plurality of transmit diversity protocols in a wireless communication system are described herein. In particular, the base station (140) generates a first signal based on a first data stream with a first pilot and a second data stream with a second pilot. That is, the first signal includes the first and second pilots. The first pilot is based on a first orthogonal code and the second pilot is based on a second orthogonal code. The base station (140) generates a second signal based on the first data stream with the first pilot and the second data stream with the second pilot such that the second signal including the first and second pilots is diverse relative to the first signal. Further, the base station (140) phase-shift modulates the first signal to produce a phase-shift modulated signal. Accordingly, the base station (140) transmits the phase-shift modulated signal via a first antenna (210) and the second signal via a second antenna (230).

### FIELD OF THE INVENTION

The present invention relates to wireless communication systems, and more particularly, to a method and a base station for providing transmit diversity in a wireless communication system.

### BACKGROUND OF THE INVENTION

A wireless communication system is a complex network of systems and elements. Typically elements include (1) a radio link to the mobile stations (e.g., cellular telephones), which is usually provided by at least one and typically several base stations, (2) communication links between the base stations, (3) a controller, typically one or more base station controllers or centralized base station controllers (BSC/CBSC), to control communication between and to manage the operation and interaction of the base stations, (4) a call controller (e.g., a mobile switching center (MSC)) or switch, typically a call agent (i.e., a “softswitch”), for routing calls within the system, and (5) a link to the land line or public switch telephone network (PSTN), which is usually also provided by the call agent.

One aspect of designing a wireless communication system is to optimize the performance of forward link or downlink transmissions. That is, the voice and packet data transmissions from a base station to a mobile station. However, multipath fading may cause multiple copies of the transmissions to be received at the mobile station with time-varying attenuation, phase shift and delay because of multiple reflections on the path.

One technique to mitigate the effects of multipath fading in a wireless communication channel is error correcting code. Along with error correction code, bit interleaving can compensate for bit errors caused by multipath fading. In particular, bit interleaving scatters the bit errors among the uncorrupted bits (i.e., “good” bits) so that the error correction codes can better correct the error bits interspersed among the “good” bits. However, the fading deep attenuation bursts must be short enough to cause a burst of bit errors that are much shorter than the bit interleaving period for the error correcting code with bit interleaving to be effective. For example, a slow moving mobile station (e.g., a mobile station used by a pedestrian or an in-building user) creates slow fading receiving channels such that fading bursts on the wireless communication channel are longer than the interleaving period. As a result, the error correction code may not compensate for the error bits.

Antenna diversity is another technique used to reduce the effect of multipath fading. In particular, multiple antennas at the reception end, e.g., the mobile station, may be used to combine, select and/or switch to improve the quality of the transmission from the transmission end, e.g., the base station. However, antenna diversity at the mobile station may be restricted by the size of the mobile station. That is, multiple receive antennas may be arranged close to each other because of the limited space on the mobile station. As a result, the antennas at mobile station are highly correlated and generate insignificant diversity gain. Therefore, transmit diversity may be used at the base station to provide diversity in the downlink path (i.e., from the base station to the mobile station) by using the two antennas normally used for receive diversity in the uplink path (i.e., from the mobile station to the base station).

Forward link or downlink performance may be improved by implementing antenna diversity on the transmission end. Wireless communication system protocols implement a number of transmit diversity protocols. For example, the IS-95 code division multiple access (CDMA) protocol may be operable to implement a phase-shift transmit diversity (PSTD) without any changes to an IS-95 mobile station. The CDMA 2000-1X protocol may be operable to implement PSTD without any changes to a CDMA 2000-1X mobile station or to implement either orthogonal transmit diversity (OTD) or space time spreading transmit diversity (STS-TD) with a specialized CDMA 2000-1X mobile station. As noted above, slow moving mobile stations create slow fading receiving channels such that deep fading attenuation bursts on a particular channel may be longer than the interleaving depth and may not have enough correct bits for error correction coding. PSTD converts slow fading to fast artificial fading at a phase sweep rate (e.g., 50 Hz) such that the error correction coding with bit interleaving may correct the error bits. Thus, applying PSTD to slow moving mobile stations reduces the transmit power of the base station necessary to achieve the desired bit error rate of the mobile station and to enable more mobile stations to be served simultaneously by the base station, i.e., increasing the average cell capacity.

Typically, mobile stations have to be adapted to receive particular kinds of transmit diversity but some wireless communication system protocols may not be compatible with certain transmit diversity protocols. For example, if a mobile station is operating under the IS-95 PSTD protocol then the mobile station is not operable for the CDMA 2000-1X OTD or STS-TD protocol. As a result, communication system needs an overlay between multiple transmit diversity protocols such that multiple transmit diversity protocols may co-exist on the same frequency band. That is, a need exists for an overlay between the CDMA 2000-1X OTD or STS-TD protocol and the IS-95 PSTD protocol on the same frequency band to accommodate, for example, the gradual upgrade from IS-95 PSTD protocol to CDMA 2000-1X OTD or STS-TD protocol. However, the mobile stations operating under CDMA 2000-1X OTD or STS-TD protocol may experience degradation because of IS-95 PSTD protocol.

Therefore, a need exists for avoiding or minimizing the degradation associated with multiple transmit diversity protocols operating on the same frequency band.

### BRIEF DESCRIPTION OF THE DRAWINGS

FIG. 1 is a block diagram representation of a wireless communication system that may be adapted to operate in accordance with the preferred embodiments of the present invention.

FIG. 2 is a block diagram representation of a communication cell that may be adapted to operate in accordance with the preferred embodiments of the present invention.

FIG. 3 is a block diagram representation of a base station that may be adapted to operate in accordance with the preferred embodiments of the present invention.

FIG. 4 is a block diagram representation of a base station that may be adapted to operate in accordance with an alternate embodiment of the present invention.

FIG. 5 is a flow diagram illustrating a method for providing transmit diversity in accordance with the preferred embodiments of the present invention.

### DETAILED DESCRIPTION OF THE PREFERRED EMBODIMENTS

Preferred embodiments of a method and a base station for providing transmit diversity in a wireless communication system are described. The wireless communication system provides communication services to a plurality of mobile stations. In particular, a base station provides transmit diversity by generating a first signal based on a first data stream with a first pilot and a second data stream with a second pilot. That is, the first signal includes the first and second pilots. The first pilot is based on a first orthogonal code and the second pilot is based on a second orthogonal code. The first and second orthogonal codes may be, but are not limited to, Walsh codes such as W0 and W16. The base station generates a second signal based on the first data stream with the first pilot and the second data stream with the second pilot such that the second signal including the first and second pilots is diverse relative to the first signal. Further, the base station phase-shift modulates the first signal to produce a phase-shift modulated signal. Accordingly, the base station transmits the phase-shift modulated signal via a first antenna and the second signal via a second antenna to the plurality of mobile stations. In an alternate embodiment, the phase-shift modulated signal may be a first phase-shift modulated signal such that the base station may also phase-shift modulates the second signal to produce a second phase-shift modulated signal. As a result, the base station transmits the second phase-shift modulated signal via the second antenna. The mobile station 160 receives the first signal 250 and the second signal 260 as one of ordinary skill in the art will readily recognize.

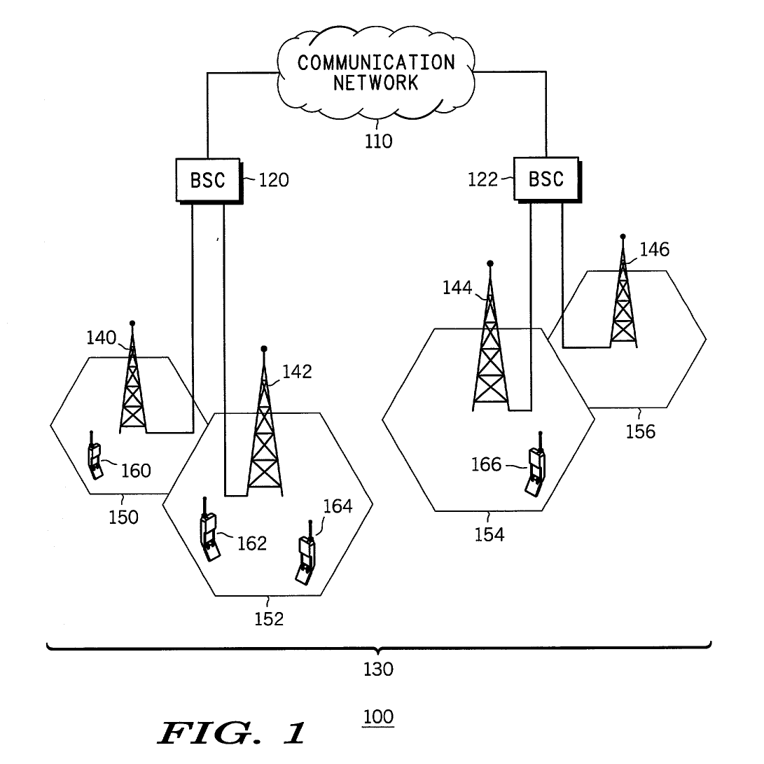

A communication system in accordance with the present invention is described in terms of several preferred embodiments, and particularly, in terms of a wireless communication system operating in accordance with at least one of several standards. These standards include analog, digital or dual-mode communication system protocols such as, but not limited to, the Advanced Mobile Phone System (AMPS), the Narrowband Advanced Mobile Phone System (NAMPS), the Global System for Mobile Communications (GSM), the IS-55 Time Division Multiple Access (TDMA) digital cellular, the IS-95 Code Division Multiple Access (CDMA) digital cellular, CDMA 2000, the Personal Communications System (PCS), 3G and variations and evolutions of these protocols. As shown in FIG. 1, a wireless communication system 100 includes a communication network 110, a plurality of base station controllers (BSC), generally shown as 120 and 122, servicing a total service area 130. The wireless communication system 100 may be, but is not limited to, a frequency division multiple access (FDMA) based communication system, a time division multiple access (TDMA) based communication system, and code division multiple access (CDMA) based communication system. As is known for such systems, each BSC 120 and 122 has associated therewith a plurality of base stations (BS), generally shown as 140, 142, 144, and 146, servicing communication cells, generally shown as 150, 152, 154, and 156, within the total service area 130. The BSCs 120 and 122, and base stations 140, 142, 144, and 146 are specified and operate in accordance with the applicable standard or standards for providing wireless communication services to mobile stations (MS), generally shown as 160, 162, 164, and 166, operating in communication cells 150, 152, 154, and 156, and each of these elements are commercially available from Motorola, Inc. of Schaumburg, Ill.

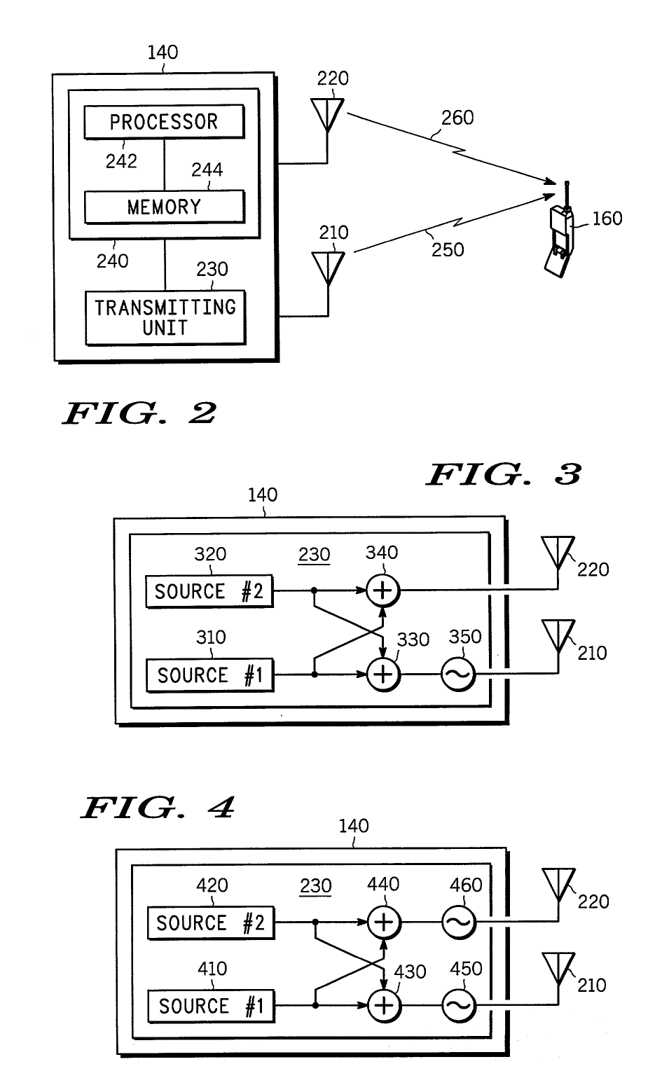

Referring to FIG. 2, the communication cell 150 generally includes a base station 140 and a plurality of mobile stations with one shown as 160. In particular, the base station 140 generally includes a first antenna 210, a second antenna 220, a transmitting unit 230 and a controller 240. The first and second antennas 210 and 220 are operatively coupled to the transmitting unit 230 as described in further details below. In an alternate embodiment, a plurality of antennas may be operatively coupled to the transmitting unit 230. The transmitting unit 230 is operatively coupled to the controller 240, which includes, but is not limited to, a processor 242 and a memory 244. The processor 242 is operatively coupled to the memory 244, which stores a program or a set of operating instructions for the processor 242. The processor 242 executes the program or the set of operating instructions such that the base station 140 operates in accordance with a preferred embodiment of the invention. The program or the set of operating instructions may be embodied in a computer-readable medium such as, but not limited to, paper, a programmable gate array, application specific integrated circuit, erasable programmable read only memory, read only memory, random access memory, magnetic media, and optical media.

To provide a plurality of transmit diversity protocols such as, but not limited to, an orthogonal transmit diversity (OTD) protocol, a space time spreading transmit diversity (STS-TD) protocol, and a phase-shift transmit diversity (PSTD) protocol, the base station 140 transmits a first signal 250 via the first antenna 210 and a second signal 260 via the second antenna 220 to the mobile station 160. In particular, the first signal 250 may be, but is not limited to, a combination of a first data stream with a first pilot and a second data stream with a second pilot. The first and second pilots may be based on, but not limited to, orthogonal codes such as Walsh codes (e.g., W0 and W16). The second signal 260 may be a phase-shift modulated signal produced from a combination of the first and second data streams. Accordingly, the second signal 260 may include the first pilot and the second pilot. However, the second signal 260 is diverse relative to the first signal 250. That is, the first antenna 210 and the second antenna 220 are spatially separated such that the attenuation and the phase shift of the multiplicative transfer functions of the two transmission paths (i.e., “channels”) associated with the first and second signals 250, 260 are distinct and independent of one another as possible. Further, if the two transmission paths of the first and second signals 250, 260 are uncorrelated (i.e., including statistically uncorrelated fading amplitude and phase fluctuations) then a transmit diversity gain may be generated. The transmit diversity gain is dependent on the correlation of the channels (i.e., a correlation factor) such that the transmit diversity gain monotonically decreases as the correlation factor increases. For example, the transmit diversity gain reaches its maximum potential when the channels are fully uncorrelated, i.e., a correlation factor of zero. Accordingly, a correlation factor of one (1) (i.e., the channels are fully correlated) results in no transmit diversity gain or even a loss.

Referring to FIG. 3, the first signal 250 is transmitted by the first antenna 210, and the second signal 260 is transmitted by the second antenna 220. The two antennas 210, 220 are spatially separated so that the transfer functions of the two transmission paths (i.e., channels) to a mobile station may be as independent as possible thus providing spatial diversity. That is, the two signals transmitted via the channels may have two statistically uncorrelated fading amplitude and phase fluctuations to enable transmit diversity gain.

As shown in FIG. 3, the base station 140 generally includes a first antenna 210, a second antenna 220 and a transmitting unit 230. In particular, the transmitting unit 230 generally includes a first data source 310, a second data source 320, a first combination circuit 330, a second combination circuit 340, and a phase-shift modulator 350. The first combination circuit 330 is operatively coupled to the first data source 310, the second data source 320, and the phase-shift modulator 350. The phase-shift modulator 350 is operatively coupled to the first antenna 210. The second combination circuit 340 is operatively coupled to the first data source 310, the second data source 320, and the second antenna 220.

A basic flow for providing a plurality of transmit diversity protocols that may be applied with the preferred embodiment of the present invention shown in FIG. 3 may start with the first combination circuit 330 generating a first signal based on a first data stream from the first data source 310 and a second data stream from the second data source 320. In particular, the first data stream includes a first pilot based on a first orthogonal code and the second data stream includes a second pilot based on a second orthogonal code. Each of the first and second orthogonal codes may be, but is not limited to, a Walsh code. For example, the first combination circuit 330 may combine the first data stream and the second data stream to produce the first signal, which includes the first pilot and the second pilot. Further, the first signal is phase-shift modulated by the phase-shift modulator 350 to produce a phase-shift modulated signal. In particular, the first signal may be combined with a phase-shift parameter such that the first signal is phase-shift modulated to provide a monotonic phase sweep of approximately 360° or a non-zero integer multiple of approximately 360° in one bit interleaving period. For example, the bit interleaving period for the IS-95 protocol may be 20 millisecond (msec) frames. Thus, the phase-shift period may be 20 msec or an integer fraction of 20 msec. Accordingly, the first antenna 210 transmits the phase-shift modulated signal. The second combination circuit 340 generates a second signal also based on the first data stream from the first data source 310 and the second data stream from the second data source 320. However, the second signal is diverse relative to the first signal. For example, the first signal may include the first pilot based on a W0 Walsh code and the second pilot based on a W16 Walsh code whereas the second signal may include the first pilot based on a W0 Walsh code but the second pilot based on a negative W16 Walsh code. The second antenna 220 transmits the second signal. Thus, a mobile station receives the phase-shift modulated signal and the second signal as one of ordinary skill in the art will readily recognize.

Implementation of the CDMA 2000-1X Space-Time Spreading Transmit Diversity (STS-TD) standard may require two STS signals (e.g., STS1 and STS2) to be transmitted separately by two transmit antennas (e.g., TxA1 and TxA2). For example, the transmit antenna TxA1 may transmit the signal STS1 and the transmit antenna TxA2 may transmit the signal STS2. The content of the two STS signals STS1 and STS2 are based on the CDMA 2000-1X STS-TD standard. Implementation of the CDMA 2000-1X Orthogonal Transmit Diversity (OTD) may also require two OTD signals (e.g., OTD1 and OTD2) to be transmitted separately by the two transmit antennas (e.g., TxA1 and TxA2). Based on the CDMA 2000-1X STS standard, the signal OTD1 includes the odd numbered data symbols whereas the signal OTD2 includes the even numbered data symbols.

Referring again to FIG. 3, in one application to provide CDMA 2000-1X space time spreading (STS) transmit diversity in combination with PSTD, the first data source 310 is adapted to provide an IS-95 compatible signal, i.e, a signal including a primary pilot using Walsh code W0 and the CDMA 2000-1X signal STS1 as described above. The second data source 320 is adapted to provide the CDMA2000-1X signal STS2 as described above and a diversity pilot using Walsh code W16. These signals are combined, e.g., summed, for transmission from the antenna 210. These signals are also combined, e.g., subtracted, and phase-shift modulated for transmission from the antenna 220.

To provide CDMA 2000-1X orthogonal transmit diversity (OTD), the first data source is again adapted to provided an IS-95 compatible signal including a primary pilot and the CDMA 2000-1X signal STS1. The second data source 320 is adapted to provide a CDMA2000-1X compatible signal including a diversity pilot and the CDMA 2000-1X signal STS2.

An IS-95 compatible mobile station receives an IS-95 compatible sum of the signals transmitted via the antennas 210 and 220. Because of the introduced phase-shift modulation (i.e., phase sweep), the sum of the two signals arriving from the two antennas 210 and 220 (i.e., a received signal) has PSTD induced fast fading. The received signal is then demodulated and decoded by the IS-95 mobile station. The received signal may be represented for a general phase sweep function, p(t), based on time t as:

R(t)=S(t)[C_{A}+C_{B} exp(j p(t)]

The received signal may be represented for a linear phase sweep as:

R(t)=S(t)[C_{A}+C_{B} exp(j2πF_{sw}t)]

Where: R(t) is the received signal, S(t) is the transmitted IS-95 signal, C_{A} and C_{B} are the communicated channels from the antennas 210 and 220, respectively, to the mobile station, t denotes time, p(t) is the general phase sweep function of time t, and F_{sw} is the phase sweep frequency deviation, which may be non-zero integer multiples of 50 Hz for IS-95 20 msec frames.

For a mobile station adapted to for either CDMA 2000-1X OTD or STS-TD transmit diversity, the two new equivalent channels (i.e., C₁ and C₂) received by the mobile station may be represented for a general phase sweep function of time t, p(t), as:

C₁=C_{A}+C_{B} exp(j p(t))

C₂=C_{A}−C_{B} exp(j p(t))

The new equivalent channels may also be represented for a linear phase sweep with a frequency deviation F_{sw} as:

C₁=C_{A}+C_{B} exp(j2πF_{sw})

C₂=C_{A}−C_{B} exp(j2πF_{sw})

Where: C_{A} and C_{B} are the communicated channels from the antennas 210 and 220, respectively; t denotes time, p(t) is the general phase sweep function of time t and F_{sw} is the linear phase sweep frequency deviation, which may be non-zero integer multiples of 50 Hz for IS-95 20 msec frames.

For example, if the linear phase sweep frequency F_{sw} is zero (0), i.e., no phase sweep, the new equivalent channels received by the mobile station may be represented as:

C₁=C_{A}+C_{B}

C₂=C_{A}−C_{B}

The new equivalent channels C₁ and C₂ will have zero cross-correlation whenever the original channels C_{A} and C_{B} have zero cross-correlation. When the original channels are correlated, i.e., the channels have non-zero cross-correlation, it can be shown that if C_{A} and C_{B} are correlated Rayleigh fading channels with symmetrical power spectral density around the carrier center frequency (i.e., complex random variables whose real and imaginary parts are independent and identically distributed Gaussian random processes), the cross-correlation of the new equivalent channels C₁ and C₂, will be zero. Even if spectral density symmetry does not hold, a reduction in correlation may be achieved, i.e., the correlation of C₁ and C₂ may be smaller than the correlation of C_{A} and C_{B}.

In an alternate embodiment, the transmitting unit 230 may include two phase-shift modulators such that the second signal from the second combination circuit 340 may also be phase-shift modulated. Referring to FIG. 4, the transmitting unit 230 includes a first data source 410, a second data source 420, a first combination circuit 430, a second combination circuit 440, a first phase-shift modulator 450, and a second phase-shift modulator 460. The first combination circuit 430 is operatively coupled to the first data source 410, the second data source 420, and the first phase-shift modulator 450, which in turn, is operatively coupled to the first antenna 210. The second combination circuit 440 is operatively coupled to the first data source 410, the second data source 420, and the second phase-shift modulator 460, which in turn, is operatively coupled to the second antenna 220.

A basic flow for providing a plurality of transmit diversity protocols that may be applied with the preferred embodiment of the present invention shown in FIG. 4 may start with the first combination circuit 430 generating a first signal based on a first data stream from the first data source 410 and a second data stream from the second data source 420. Accordingly, the first signal is modulated by the first phase-shift modulator 450 to produce a first phase-shift modulated signal, which in turn, is transmitted via the first antenna 210. The second combination circuit 440 generates a second signal also based on the first data stream from the first data source 410 and the second data stream from the second data source 420. However, the second signal is diverse relative to the first signal. Further, the second signal is phase-shift modulated by the second phase-shift modulator 460 to produce a second phase-shift modulated signal. The second antenna 220 transmits the second phase-shift modulated signal. As a result, a mobile station receives two phase-shift modulated signals, i.e., the first and second phase-shift modulated signals.

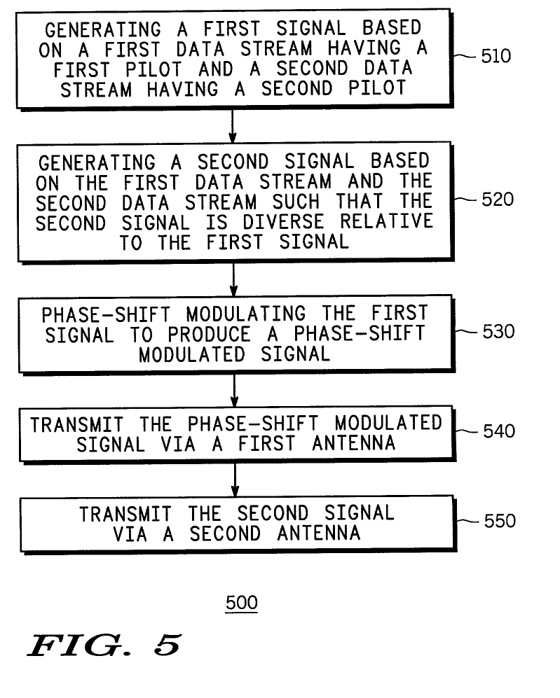

In accordance with the preferred embodiments of the present invention, and with references to FIG. 5, a method 500 for providing a plurality of transmit diversity protocols in a wireless communication system is shown. Method 500 begins at step 510, where a controller of a base station generates a first signal based on a first data stream including a first pilot and a second data stream including a second pilot. That is, the first signal includes the first and second pilots. For example, the controller may combine the first data stream and the second data stream to produce the first signal including the first and second pilots. The first and second pilots may be based on, but are not limited to, orthogonal codes such as Walsh codes (e.g., W0 and W16). At step 520, the controller generates a second signal based on the first data stream and the second data stream such that the second signal is diverse relative to the first signal. Even though the second signal is diverse relative to the first signal, the second signal also includes the first and second pilots. At step 530, the controller phase-shift modulates the first signal to produce a phase-shift modulated signal. That is, the controller combines the first signal with a phase-shift parameter to produce the phase-shift modulated signal. For example, the first signal may be phase-shift modulated with a phase sweep of an integer multiple of 360° over one bit interleaving period. A linear phase sweep of 360° degrees over an IS-95 bit interleaving period of 20 msec results in a 50 Hz phase sweep frequency deviation. In an alternate embodiment, the phase-shift modulated signal may be a first phase-shift modulated signal such that the controller may also phase-shift modulate the second signal to produce a second phase-shift modulated signal. The first and second phase-shift modulated signals are phase-shift modulated with a phase sweep of an integer multiple of 360° over one bit interleaving period. For example, the first phase-shift modulated signal may be phase-shift modulated with a phase sweep of 180° in a direction and the second phase-shift modulated signal may be phase-shift modulated with a phase sweep of 180° in an opposite direction. At step 540, the controller transmits the phase-shift modulated signal via a first antenna. At step 550, the controller transmits the second signal via a second antenna. As noted above, the second signal may be phase-shift modulated in an alternate embodiment such that the second antenna may transmit the second phase-shift modulated signal. Accordingly, the base station provides transmit diversity with the first and second antennas.

Many changes and modifications could be made to the invention without departing from the fair scope and spirit thereof. The scope of some changes is discussed above. The scope of others will become apparent from the appended claims.

What is claimed:

1. In a wireless communication system, the communication system providing communication services to a plurality of mobile stations, a method for providing a plurality of transmit diversity protocols, the method comprising:
generating a first signal based on a first data stream having a first pilot and a second data stream having a second pilot, the first signal including the first and second pilots;
generating a second signal based on the first data stream having the first pilot and the second data stream having the second pilot such that the second signal is diverse relative to the first signal, the second signal including the first and second pilots;
phase-shift modulating the first signal to produce a phase-shift modulated signal;
transmitting the phase-shift modulated signal via a first antenna; and
transmitting the second signal via a second antenna,
wherein the first pilot is based on a first orthogonal code and the second pilot is based on a second orthogonal code.

2. The method of claim 1, wherein the step of generating the first signal based on the first data stream having the first pilot and the second data stream having the second pilot comprises combining the first data stream and the second data stream such that the first signal includes the first pilot and the second pilot, and wherein each of the first and second pilots is based on a Walsh code.

3. The method of claim 1, wherein the step of generating the first signal based on the first data stream having the first pilot and the second data stream having the second pilot comprises generating the first signal based on a first data stream having a first pilot based on a Walsh code W0 and a second data stream having a second pilot based on a Walsh code W16.

4. The method of claim 1, wherein the step of phase-shift modulating the first signal to produce a phase-shift modulated signal comprises combining the first signal with a phase-shift parameter, and wherein the phase-shift parameter comprises a phase sweep of 360° for a bit interleaving period.

5. The method of claim 1, wherein the step of phase-shift modulating the first signal to produce a phase-shift modulated signal comprises combining the first signal with a phase-shift parameter, and wherein the phase-shift parameter comprises a phase sweep operable at an integer multiple of 360° for a bit interleaving period of 20 milliseconds.

6. The method of claim 1, wherein the step of generating the second signal based on the first data stream having the first pilot and the second data stream having the second pilot comprises combining the first and second data streams such that the second signal includes the first pilot and the second pilot, and wherein each of the first and second pilots is based on a Walsh code.

7. The method of claim 1, wherein the step of generating the second signal based on the first data stream having the first pilot and the second data stream having the second pilot comprises generating a second signal based on a first data stream having a first pilot based on a Walsh code W0 and a second data stream having a second pilot based on a Walsh code W16 such that the second signal is diverse relative to the first signal.

8. The method of claim 1, wherein the phase-shift modulated signal comprises a first phase-shift modulated signal, and further comprising the steps of phase-shift the second signal to produce a second phase-shift modulated signal.

9. The method of claim 8, wherein the step of transmitting a second signal via a second antenna comprises transmitting a second phase-shift modulated signal via a second antenna.

10. The method of claim 1, wherein the communication system operates in accordance with one of a CDMA 2000-1X communication protocol and an IS-95 communication protocol.

11. The method of claim 1, wherein the plurality of transmit diversity protocols comprises one of an orthogonal transmit diversity (OTD) protocol, a space time spreading transmit diversity (STS-TD) protocol, and a phase-shift transmit diversity (PSTD) protocol.

12. In a wireless communication system, the communication system providing communication services to a plurality of mobile stations, a base station for providing a plurality of transmit diversity protocol, the base station comprising:
a first data stream source adapted to provide a first data stream having a first pilot, the first pilot is based on a first orthogonal code;
a second data stream source adapted to provide a second data stream having a second pilot, the second pilot is based on a second orthogonal code;
a first signal generator adapted to generate a first signal based on the first data stream and the second data stream, the first signal including the first and second pilots;
a second signal generator adapted to generate a second signal based on the first data stream and the second data stream such that the second signal is diverse relative to the first signal, the second signal including the first and second pilots;
a phase-shift modulator coupled to the first signal generator, the phase-shift modulator being operable to modulate the first signal to produce a phase-shift modulated signal;
a first antenna coupled to the phase-shift modulator, the first antenna being operable to transmit the phase-shift modulated signal; and
a second antenna coupled to the second signal generator, the second antenna being operable to transmit the second signal.

13. The base station of claim 12, wherein each of the first and second orthogonal codes comprises a Walsh code.

14. The base station of claim 12, wherein the first orthogonal code comprises a Walsh code W0.

15. The base station of claim 12, wherein the second orthogonal code comprises a Walsh code W16.

16. The base station of claim 12, wherein the first signal generator comprises a first signal combination circuit, wherein the first signal combination circuit is operable to combine the first data stream and the second data stream to produce the first signal.

17. The base station of claim 12, wherein the second signal generator comprises a second signal combination circuit, wherein the second signal combination circuit is operable to combine the first data stream and the second data stream to produce the second signal, and wherein the second signal is diverse relative to the first signal.

18. The base station of claim 12, wherein the phase-shift modulator comprises a phase-shift modulator operable to combine the first signal with a phase-shift parameter, and wherein the phase-shift parameter comprises one of a phase sweep of 360° for a bit interleaving period and a phase sweep operable at an integer multiple of 360° for a bit interleaving period of 20 milliseconds.

19. The base station of claim 12, wherein the phase-shift modulator comprises a first phase-shift modulator operable to modulate the first signal to produce a first phase-shift modulated signal, and further comprising a second phase-shift modulator operatively coupled to the second signal generator, wherein the second phase-shift modulator is operable to modulate the second signal to produce a second phase-shift modulated signal.

20. The base station of claim 19, wherein the second antenna comprises an antenna operatively coupled to the second phase-shift modulator, and wherein the antenna is operable to transmit the second phase-shift modulated signal.

21. The base station of claim 12, wherein the base station operates in accordance with one of a CDMA 2000-1X communication protocol and an IS-95 communication protocol.

22. The base station of claim 12, wherein the plurality of transmit diversity protocols comprises one of an orthogonal transmit diversity (OTD) protocol, a space time spreading transmit diversity (STS-TD) protocol, and a phase-shift transmit diversity (PSTD) protocol.

23. In a wireless communication system, the communication system for providing communication service for a plurality of mobile stations, wherein a processor operates in accordance with a computer program embodied on a computer-readable medium for providing a plurality of transmit diversity protocols, the computer program comprising:
a first routine that directs the processor to generate a first signal based on a first data stream having a first pilot and a second data stream having a second pilot, the first signal including the first and second pilots;
a second routine that directs the processor to generate a second signal based on the first data stream having the first pilot and the second data stream having the second pilot such that the second signal is diverse relative to the first signal, the second signal including the first and second pilots;
a third routine that directs the processor to phase-shift modulate the first signal to produce a phase-shift modulated signal;
a fourth routine that directs the processor to transmit the phase-shift modulated signal via a first antenna; and
a fifth routine that directs the processor to transmit the second signal via a second antenna,
wherein the first pilot is based on a first orthogonal code and the second pilot is based on a second orthogonal code.

24. The computer program of claim 23, wherein the first routine comprises a routine that directs the processor to combine the first data stream and the second data stream such that the first signal includes the first pilot and the second pilot, and wherein each of the first and second pilots is based on a Walsh code.

25. The computer program of claim 23, wherein the first routine comprises a routine that directs the processor to generate the first signal based on a first data stream having a first pilot based on a Walsh code W0 and a second data stream having a second pilot based on a Walsh code W16.

26. The computer program of claim 23, wherein the second routine comprises a routine that directs the processor to combine the first and second data streams such that the second signal includes the first pilot and the second pilot, and wherein each of the first and second pilots is based on a Walsh code.

27. The computer program of claim 23, wherein the second routine comprises a routine that directs the processor to generate a second signal based on a first data stream having a first pilot based on a Walsh code W0 and a second data stream having a second pilot based on a Walsh code W16 such that the second signal is diverse relative to the first signal.

28. The computer program of claim 23, wherein the third routine comprises a routine that directs the processor to combine the first signal with a phase-shift parameter, and wherein the phase-shift parameter comprises a phase sweep of 360° for a bit interleaving period.

29. The computer program of claim 23, wherein the third routine comprises a routine that directs the processor to combine the first signal with a phase-shift parameter, and wherein the phase-shift parameter comprises a phase sweep operable at an integer multiple of 360° for a bit interleaving period of 20 milliseconds.

30. The computer program of claim 23, wherein the phase-shift modulated signal comprises a first phase-shift modulated signal, and further comprising a routine that directs the processor to phase-shift modulate the second signal to produce a second phase-shift modulated signal.

31. The computer program of claim 30, wherein the fifth routine comprises a routine that directs the processor to transmit the second phase-shift modulated signal via the second antenna.

32. The computer program of claim 23, wherein the computer program operates in accordance with one of a CDMA 2000-1X communication protocol and an IS-95 communication protocol.

33. The computer program of claim 23, wherein the plurality of transmit diversity protocols comprises one of an orthogonal transmit diversity (OTD) protocol, a space time spreading transmit diversity (STS-TD) protocol, and a phase-shift transmit diversity (PSTD) protocol.

34. The computer program of claim 23, wherein the medium is one of paper, a programmable gate array, application specific integrated circuit, erasable programmable read only memory, read only memory, random access memory, magnetic media, and optical media.
